(19) United States
(12) Patent Application Publication
(10) Pub. No.: US 2020/0002124 A1
(43) Pub. Date: Jan. 2, 2020

(54) ELEVATOR USAGE IN VENUES

(71) Applicant: HERE GLOBAL B.V., Eindhoven (NL)

(72) Inventors: Lauri Aarne Johannes WIROLA, Tampere (FI); Jouni KAMARAINEN, Tampere (FI)

(21) Appl. No.: 16/023,655

(22) Filed: Jun. 29, 2018

(51) Int. Cl. B66B 1/34; G01C 21/20; B66B 5/02; B66B 3/00

(52) U.S. Cl. CPC B66B 1/3492; G01C 21/206; B66B 5/027; B66B 2201/403; B66B 2201/402; B66B 2201/222; B66B 3/00

(57) ABSTRACT

A method, apparatus, computer program product and system are provided that are configured to obtain a plurality of pieces of movement information that is at least indicative of an origin location and a destination location in a venue; obtain indoor map data of the venue that is indicative of one or more connections one or more users can utilize for transferring between floors of the venue and that comprises or is associated with pre-determined route information; and determine one or more pieces of control information for one or more elevators of the venue based at least partially on the plurality of pieces of movement information and the indoor map data. The control information enables a controlling of a respective elevator of the one or more elevators. The one or more pieces of control information influence an overall elevator usage of the one or more elevators of the venue.

### FIELD

The following disclosure relates to the field of indoor positioning, or more particularly relates to systems, apparatuses, and methods for determining control information for one or more elevators in a venue.

### BACKGROUND

Indoor positioning requires novel systems and solutions that are specifically developed and deployed for this purpose. The “traditional” positioning technologies, which are mainly used outdoors, i.e. satellite and cellular positioning technologies, cannot deliver such performance indoors that would enable seamless and equal navigation experience in both environments. The required positioning accuracy (2-3 m), coverage (˜100%) and optionally floor detection are challenging to achieve with satisfactory performance levels with the systems and signals that were not designed and specified for the indoor use cases in the first place. Satellite-based radio navigation signals simply do not penetrate through the walls and roofs for the adequate signal reception and the cellular signals have too narrow bandwidth for accurate ranging by default.

Several indoor-dedicated solutions have already been developed and commercially deployed during the past years, e.g. solutions based on pseudolites (GPS (Global Positioning System)-like short-range beacons), ultra-sound positioning, BTLE (Bluetooth Low Energy) signals (e.g. High-Accuracy Indoor Positioning, HAIP) and Wi-Fi fingerprinting. What is typical to these solutions is that they require either deployment of totally new infrastructure (beacons, tag, or the like) or manual exhaustive radio surveying of the buildings including all the floors, spaces and rooms. This is rather expensive and will take a considerable amount of time to build the coverage to the commercially expected level, which in some cases narrowed the potential market segment only to a very thin customer base e.g. for health care or dedicated enterprise solutions. Also, the diversity of these technologies makes it difficult to build a globally scalable indoor positioning solution, and the integration and testing will become complex if a large number of technologies needs to be supported in the consumer devices, such as smartphones.

When it comes to modern large and/or high-rise venues (e.g. buildings, especially office buildings), there is a fundamental challenge in moving people effectively between floors. Optimizing these flows requires e.g. optimizing corridors, access control systems, elevator usage, etc. Nowadays, a smooth travel indoors is becoming as valued as fluent traffic outdoors. The future office buildings may even differentiate from other buildings with smooth travel across the building.

Today buildings can be equipped with sensors that sense the amount of people in floors and corridors. Potentially, the sensors also understand the flow: for example, how many people are moving along the corridor to the elevators. While this provides information on how many elevators are needed in a specific floor, it does not yet allow making further optimization, because there is no information to which floor the people want to go to.

Further, often times such sensors may also overestimate the number of people requiring elevator access, since not all people moving along the corridor may use the elevator.

### SUMMARY OF SOME EXEMPLARY EMBODIMENTS

The ever-higher buildings require more elevators to provide efficient flow of users (e.g. visitors, employees) between floors. The conventional solution to this problem is to have extra elevator capacity. Obviously, this has significant negative effects, e.g. increased costs and less useful space, because more space is taken up by elevator shafts.

It is thus, inter alia, an object of the present invention to achieve a solution for optimizing the usage of one or more elevators in a venue.

According to a first exemplary aspect of the present invention, a method is disclosed, the method comprising:
obtaining a plurality of pieces of movement information, wherein a respective movement information of the plurality of pieces of movement information is at least indicative of an origin location and a destination location in a venue;
obtaining indoor map data of the venue in case the indoor map data is not available, wherein the indoor map data is indicative of at least one or more connections one or more users can utilize for transferring between floors of the venue, wherein the indoor map data comprises or is associated with one or more pre-determined route information indicative of a pre-determined route within the venue; and
determining one or more pieces of control information for one or more elevators of the venue based at least partially on the plurality of pieces of movement information and the indoor map data, wherein a respective control information of the one or more pieces of control information enables a controlling of a respective elevator of the one or more elevators, and wherein the one or more pieces of control information together enable to influence an overall elevator usage of the one or more elevators of the venue.

This method may for instance be performed and/or controlled by an apparatus, for instance a server. Alternatively, this method may be performed and/or controlled by more than one apparatus, for instance a server cloud comprising at least two servers.

According to a further exemplary aspect of the invention, a computer program is disclosed, the computer program when executed by a processor causing an apparatus, for instance a server, to perform and/or control the actions of the method according to the first exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect of the invention, an apparatus is disclosed, configured to perform and/or control or comprising respective means for performing and/or controlling the method according to the first exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the first exemplary aspect.

The above-disclosed apparatus according to any aspect of the invention may be a module or a component for a device, for example a chip. Alternatively, the disclosed apparatus according to any aspect of the invention may be a device, for instance a server or server cloud. The disclosed apparatus according to any aspect of the invention may comprise only the disclosed components, for instance means, processor, memory, or may further comprise one or more additional components.

According to a second exemplary aspect of the present invention, a method is disclosed, the method comprising:
gathering a movement information indicative of an origin location and a destination location in a venue;
outputting the movement information;
receiving one or more pieces of control information that enable a controlling of one or more elevators of the venue; and
determining navigation information based on the movement information and the one or more pieces of control information, wherein the navigation information enables to navigate a user in the venue from the origin location to the destination location.

This method may for instance be performed and/or controlled by an apparatus, for instance an electronic device (e.g. smartphone, tablet, wearable, IoT (Internet-of-Things) device). For instance, the method may be performed and/or controlled by using at least one processor of the electronic device.

According to a further exemplary aspect of the invention, a computer program is disclosed, the computer program when executed by a processor causing an apparatus, for instance a server, to perform and/or control the actions of the method according to the second exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect of the invention, an apparatus is disclosed, configured to perform and/or control or comprising respective means for performing and/or controlling the method according to the second exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect of the invention, an apparatus is disclosed, comprising at least one processor and at least one memory including computer program code, the at least one memory and the computer program code configured to, with the at least one processor, cause an apparatus, for instance the apparatus, at least to perform and/or to control the method according to the second exemplary aspect.

The above-disclosed apparatus according to any aspect of the invention may be a module or a component for a device, for example a chip. The disclosed apparatus according to any aspect of the invention may comprise only the disclosed components, for instance means, processor, memory, or may further comprise one or more additional components.

According to a third exemplary aspect of the invention, a system is disclosed, comprising:
a plurality of apparatuses according to any aspect as disclosed above, configured to perform and/or control the method according to the second exemplary aspect of the present invention as disclosed above; and
at least one apparatus according to any aspect as disclosed above, configured to perform and/or control the method according to the first exemplary aspect as disclosed above.

Each of the plurality of apparatuses configured to perform and/or control the method according to the second exemplary aspect of the present invention as disclosed above may for instance be configured to output (e.g. sent or transmit) a movement information to the at least one apparatus configured to perform and/or control the method according to the first exemplary aspect of the present invention as disclosed above. Further, each of the plurality of apparatuses may for instance be configured to receive one or more pieces of control information from the at least one apparatus.

In the following, exemplary features and exemplary embodiments of all aspects of the present invention will be described in further detail.

The venue may for instance be a building, shopping mall, office building, office complex, public accessible location (e.g. station, airport, library, university or the like), to name but a few non-limiting examples. In particular, the venue within the meaning of the present invention may comprise at least two floors and at least one elevator being configured to transfer one or more users between the at least two floors of venue. Such a venue may for instance be a high-rise and/or large building (e.g. office building) comprising a plurality of floors and a plurality of elevators.

The term user or the plural term users as used herein refers to e.g. visitors of the venue and is used generically, e.g. to mean employees, visitors, personnel, inhabitants, or the like, to name but a few non-limiting examples. Thus, the term user(s) within the meaning of the present invention refers to any person(s) moving about and/or being located in the venue.

The plurality of pieces of movement information may for instance be obtained (e.g. received). The plurality of pieces of movement information may for instance be received from a plurality of electronic device (e.g. apparatus(es) according to the second exemplary aspect of the present invention).

Each respective movement information of the plurality of pieces of movement information is indicative of an origin location (e.g. a room, a floor, a corridor of the venue, to name but a few non-limiting examples) and a destination location (e.g. a room, a floor, a corridor of the venue, to name but a few non-limiting examples) in the venue. Each respective movement information of the plurality of pieces of movement information may for instance be associated with a respective electronic device (e.g. of the plurality of electronic devices). Thus, each respective movement information of the plurality of pieces of movement information may for instance be indicative of a respective origin location, and a respective destination location a respective user of the respective electronic device wishes to reach in the venue, e.g. at a pre-determined time (e.g. represented by a corresponding time information, described in more detail below). Additionally, each of the plurality of pieces of movement information may for instance comprise or being associated with a respective (certain) electronic device (e.g. located in the venue), e.g. via a respective device identifier (e.g. IMSI (International Mobile Subscriber Identity), IMEI (International Mobile Station Equipment Identity), hardware identifier, or the like, to name but a few non-limiting examples.

The indoor map data of the venue is obtained (e.g. received) in case the indoor map data is not available. For instance, such indoor map data may be comprised by (e.g. stored in) a database comprised by or being connectable to the apparatus of the first exemplary aspect of the present invention. For instance, in case such a database is not comprised by or being connectable to the apparatus of the first exemplary aspect of the present invention, the indoor map data is obtained, e.g. by requesting the indoor map data to be transmitted to the apparatus of the first exemplary aspect of the present invention.

The indoor map data comprises or is associated with one or more pre-determined route information indicative of a pre-determined route within the venue. For instance, such a route information may represent a route from one or more (certain) origin locations of the venue to one or more (certain) destination locations of the venue. Further, e.g. all possible routes from at least one (e.g. every possible) origin location to at least one (e.g. every possible) destination location in the venue may for instance be pre-determined. Thus, the route information may for instance represent these possible routes. Further, these possible routes may for instance be associated with or being comprised by the indoor map data.

Then, one or more pieces of control information for one or more elevators of the venue are determined based at least partially on the plurality of pieces of movement information and the indoor map data. In particular, a respective control information may for instance be determined for each elevator of the one or more elevators of the venue.

A respective control information of the one or more pieces of control information enables a controlling of a respective elevator of the one or more elevators of the venue. For instance, such a respective control information may be output to the respective elevator, wherein the respective elevator is controlled based at least partially on the respective control information. In particular, the respective elevator may not be controllable by other pieces of information or inputs of one or more users, e.g. requesting the elevator to a certain floor of the venue, e.g. by a push of a button located at the entry of the respective elevator at a floor of the venue.

The overall elevator usage may for instance be influenced by balancing load between the one or more elevators of the venue. Further, the overall elevator usage may for instance be influenced by controlling at least one elevator of the one or more elevators of the venue, e.g. to avoid unnecessary transfers of the at least one elevator between two floors of the venue.

In case the venue comprises more than one elevator, by determining a respective control information for each of the more than one elevators of the venue, the overall usage of the more than one elevators can be influenced, since the respective pieces of control information for the more than one elevators are determined under consideration of the plurality of pieces of movement information, e.g. respectively gathered by a plurality of electronic devices of users, e.g. currently residing in the venue.

This method may for instance be performed and/or controlled in pre-defined or determined according to pre-defined rules time intervals. This enables a controlling of the one or more elevators based on up-to-date movement information. In this way, the overall elevator usage can be optimized, e.g. based on the most up-to-date plurality of pieces of movement information (e.g. of a plurality of electronic devices from a plurality of user, e.g. currently residing in the venue).

Thus, the one or more pieces of control information may for instance be determined based at least partially on the up-to-date plurality of pieces of movement information.

In this way, it is implicitly clear that the (e.g. externally gathered) plurality of pieces of movement information can be used to influence (e.g. optimize) the overall elevator usage (e.g. elevator control pattern(s)).

A respective control information of the one or more pieces of control information may for instance be indicative of where the respective elevator associated with the respective control information stands at a given time, and/or at which floor the respective elevator should stop, e.g. at a (e.g. any) given time. In the light of one or more pieces of control information for e.g. every elevator in the venue, the plurality of pieces of control information may for instance be indicative of, at least implicitly or by (e.g. each of the plurality of pieces of control information) comprising explicit information, which elevator of the one or more elevators of the venue stops at which floor(s) of the venue, e.g. at a given time). In this way, e.g. less elevators of the venue are needed. Further, waiting time for the one or more users of the one or more elevators of the venue can be significantly reduced.

According to an exemplary embodiment of all aspects of the present invention, the plurality of pieces of movement information are obtained based at least partially on one or more pieces of calendar information, wherein each of the one or more pieces of calendar information is indicative of a destination location and a time at which a respective user of the one or more users wishes to reach the destination location of the calendar information, wherein a respective movement information of the plurality of pieces of movement information is deduced from a current location of a respective electronic device of the respective user and the destination location of the calendar information.

The one or more pieces of calendar information may for instance be obtained (e.g. received) from one or more respective electronic devices (e.g. an apparatus according to the second exemplary aspect of the present invention). The one or more pieces of calendar information may for instance be output based on a (e.g. received) request (e.g. from an apparatus according to the first exemplary aspect of the present invention). Additionally or alternatively, the one or more pieces of calendar information may for instance be obtained from a memory, e.g. a database, in which the one or more pieces of calendar information are stored. In case the one or more pieces of calendar information are stored in a memory, in order to obtain the one or more pieces of calendar information, a respective user of a respective calendar information may for instance give his consent to obtain the respective calendar information.

Moreover, a respective origin and/or a respective destination location that is comprised by or a part of a respective movement information (of the plurality of pieces of movement information) may for instance be determined (e.g. derived from) based at least partially on such a calendar information. For instance, from a meeting room and/or place that is allocated in or represented by the respective calendar information. Thus, such a calendar information may for instance be considered as the information on where the respective user will most likely go next. Further, the respective calendar information may for instance have a time information associated with the origin and/or a respective destination location. Such a time information may for instance be further considered when determining the one or more pieces of control information for the one or more elevators of the venue.

By considering the one or more pieces of calendar information, a forecast for a required elevator of a route (e.g. travelled by one or more users) in the venue may for instance be enabled. The required elevator of the route may for instance be constantly changing based on the location(s) of the one or more users and the route(s) the user(s) will take in the venue.

According to an exemplary embodiment of all aspects of the present invention, the one or more pieces of control information are determined further based on a plurality of pieces of time information indicative of a time a user wishes to reach a destination location in the venue, wherein each of the plurality of pieces of movement information is associated with such a time information, wherein the one or more pieces of control information are determined by aggregating the plurality of pieces of movement information associated with the plurality of pieces of time information.

The respective time information of the plurality of pieces of time information may for instance be obtained (e.g. received) together with the associated movement information, e.g. as a part of obtaining the plurality of pieces of movement information.

By having (e.g. all) of the respective time information, those respective pieces of time information and pieces of movement information may for instance be aggregated to determine (e.g. achieve) optimized control information for the one or more elevators of the venue at any given time, e.g. of a day, week, month, year, to name but a few non-limiting examples.

In this way, it is enabled to determine the one or more pieces of control information for the one or more elevators so that a respective control information for a respective elevator is optimized, e.g. to balance load of users between the one or more elevators of the venue based on the corresponding (usage) time as represented by the plurality of pieces of time information.

According to an exemplary embodiment of all aspects of the present invention, at least one respective movement information of the one or more pieces of movement information comprises or is associated with a trajectory information indicative of a current direction of movement of a respective electronic device of a respective user, wherein the one or more pieces of control information are determined further based on the trajectory information.

It will be understood that each of the one or more pieces of movement information may for instance comprise or be associated with such a trajectory information. The corresponding trajectory information may for instance enable to determine whether or not the user may utilize a respective elevator of the one or more elevators. For instance, in case a respective trajectory information is indicative of the user heading to stairs connecting floors to be changed by the user, the one or more pieces of control information may for instance be determined utilizing this knowledge.

Deducing a respective origin and/or a respective destination location (e.g. floor in the venue) from the plurality of pieces of movement information may for instance be possible just by analyzing the respective calendar information associated with a respective movement information of the plurality of pieces of movement information. It may for instance be deduced, e.g. for influencing (e.g. optimizing) elevator usage of the one or more elevators of the venue, where (a) user(s) is/are located (e.g. via indoor positioning or tracking) and by using the respective calendar information associated with a respective user to determine the respective destination location. In such a case, it may for instance be enabled to deduce where the respective user is heading to in the venue (e.g. the respective user is in the floor 3 (e.g. of 7) now, and has a meeting in the floor 7 of the venue in five minutes, as represented by a respective time information of the respective calendar information, or that is associated with the respective calendar information. Then it may for instance be plausible to consider that the respective user is heading to the floor 7 of the venue.

In addition, the apparatus according to the first exemplary aspect of the present invention (e.g. a server, or server cloud) may for instance have access to the calendar information (e.g. stored in a database comprised by or being connectable to this apparatus) allowing said apparatus e.g. to deduce the most probable destination location. In this case, there might not even be any involvement e.g. of a respective electronic device of a respective user.

According to an exemplary embodiment of all aspects of the present invention, the method further comprises:
outputting the control information for usage in controlling the one or more elevators of the venue, and/or for usage in a navigation service within the venue, wherein the navigation service enables a respective electronic device of a respective user to navigate from an origin location to a destination location of the venue.

For instance, the determined one or more pieces of control information may for instance be output to the one or more elevators of the venue. This enables to optimize the overall elevator usage, since one or more users of the one or more elevators may for instance be balanced across the one or more elevators of the venue. Further, in this way, it may for instance be enabled to time the usage of the one or more elevators for the one or more users so that e.g. unnecessary usage of the one or more elevators can be avoided.

For instance, the determined one or more pieces of control information may for instance be output to respective electronic devices of the one or more users, e.g. that may for instance be located in the venue. Then, the respective electronic devices of the one or more users may for instance perform and/or control navigation services for the one or more users based at least partially on the one or more pieces of control information. In this way, it is enabled to navigate e.g. one or more respective users of the one or more users to (a) chosen elevator(s) of the one or more elevators. This enables to control the ‘flow’ of the one or more users to (a) certain elevator(s), e.g. to distribute the load between elevators (more) evenly. For instance, a respective user might need to walk e.g. 30 m more to another elevator of the venue, but the overall route to get to a respective destination location in the venue may for instance take the same amount of time or still be faster from the end-to-end route perspective, e.g. because of the elevator that is used by the user is working faster.

It will be understood that the origin location may for instance be a current location, so that the respective user is navigated to his intended destination location. The current location may for instance be updated periodically, so that the respective user may for instance be enabled to monitor his location, e.g. on an indoor map, while being navigated to the destination location in the venue.

According to an exemplary embodiment of all aspects of the present invention, the method further comprises:
determining navigation information based at least partially on a respective movement information of the plurality of pieces of movement information and the one or more pieces of control information, wherein the navigation information is indicative of a certain route enabling a respective user to get from the origin location to the destination location of the respective movement information.

Alternatively, a navigation information may for instance be determined based at least partially on a movement information that is comprised by or accompanying a (received) request. Such a request may for instance be sent from a respective electronic device of a respective user, e.g. to the apparatus according to the first exemplary aspect of the present invention. Such a request may for instance be received prior to the determining of the navigation information. In this way, a respective user of the respective electronic device may for instance be provided with navigation information enabling him to navigate to his intended destination location, e.g. based on a very specific (navigation) request. Then, the corresponding navigation information is determined under consideration of influencing (e.g. optimizing) the overall elevator usage in the venue, since the navigation information is determined based at least partially on the one or more pieces of control information.

For instance, in a case with two respective users approaching an elevator of the venue, the question may for instance arise whether one or two elevators should be called to the floor at which the two respective users are located, predictively. If the two respective users require to go up or down, one elevator is sufficient. However, if one respective user requires to go up and the other one down, then two elevators are needed. Therefore, understanding the destination locations (e.g. floor) of the users may for instance be advantageous when determining the respective control information for these two elevators of the venue in order to the overall elevator usage being optimized.

According to an exemplary embodiment of all aspects of the present invention, at least a part of the plurality of pieces of movement information is gathered by one or more sensors.

Indoor positioning or tracking, e.g. determining a current location or origin location of a respective user in the venue, may for instance be performed and/or controlled based on gathered information of one or more sensors, e.g. deployed throughout the venue. Such sensors may for instance be cameras or movement detectors enabling an information to be determined, wherein such an information may for instance be indicative of one or more users being located at a specific location in the venue.

Further, at least the current location or origin location of a respective user, gathered as described above, may for instance be determined in the apparatus according to the first exemplary aspect of the present invention (e.g. a server or a server cloud). Thus, a respective user (or all users) of the one or more users located within the venue may for instance be tracked, e.g. by the deployed one or more sensors.

According to an exemplary embodiment of all aspects of the present invention, the navigation information is determined based on a probability information indicative of a likelihood that the user utilizes a certain connection to transfer from one floor of the venue to another.

The certain connection may for instance be represented by a specific elevator or specific stairs of the venue connecting at least two different floors of the venue with each other.

The probability information may for instance be determined based at least partially on an origin location and a destination location as comprised by or represented by a respective movement information of the plurality of pieces of movement information. Thus, based on a respective movement information, a number of floors to be changed, a current trajectory of a respective electronic device that may for instance have gathered the movement information (e.g. represented by or being a part of the respective movement information), or historical movement patterns of the respective electronic device (e.g. that are derivable from the historical movement information, for more details see below), or a combination thereof, may be determined (e.g. derived).

For instance, in case there is a floor change required for getting from a respective origin location (e.g. the current location of a respective user) to a respective destination location of the venue, the floor change may for instance be done by using an elevator or by taking stairs. A probability information characterizing the likelihood of each of the aforementioned possibilities may for instance be determined (e.g. estimated), e.g. based at least partially on the number of floors to change. For instance, the higher the number of floors to change, the more probable it is that a respective user will use an elevator, and not take stairs. Further, the probability information may for instance be determined based at least partially on the trajectory information. For instance, the trajectory information may for instance be indicative of whether a respective user is heading towards stairs or towards an elevator, to name but a few non-limiting examples. Further, the probability information may for instance be determined based at least partially on the historical movement information. For instance, such a historical movement information (e.g. associated with a respective user) may for instance be indicative of a number of cases the respective user has taken stairs or the user has been using one or more elevators of the venue in the past.

According to an exemplary embodiment of all aspects of the present invention, a respective control information of the one or more pieces of control information for a respective elevator of the one or more elevators of the venue is determined further based on one or more of the following parameters i) to iii), which are deducable from the plurality of pieces of movement information:
i) number of users requiring an elevator in an origin floor of the respective elevator;
ii) number of users requiring an elevator in a destination floor of the respective elevator; and
iii) number of users requiring an elevator in one or more floors in between the origin floor and the destination floor of the respective elevator.

In order to determine the one or more pieces of control information, e.g. the number of users needing a respective elevator in an origin and/or destination location (e.g. floor) of the venue (e.g. at any given time of the day, week, month, year, to name but a few non-limiting examples) may for instance be deduced from the plurality of pieces of movement information. Further, the respective (intended) origin and/or destination location(s) of the one or more users may for instance be deduced from the plurality of pieces of movement information as well, e.g. understanding where those one or more users want to move in the venue. Further, the number of users in one or more floors in between the origin floor and the destination floor of the respective elevator may for instance be determined (e.g. deduced) from the plurality of pieces of movement information. The deducing may for instance be performed and/or controlled by aggregating the plurality of pieces of movement information, and then analyzing the aggregated information to deduce at least one of the parameters i) to iii).

In this way, the one or more parameters i) to iii) may for instance be determined (e.g. deduced) based on the plurality of pieces of movement information.

According to an exemplary embodiment of all aspects of the present invention, the indoor map data is indicative of one or more of the following:
i) a model of the venue;
ii) one or more points-of-interest of the venue; and
iii) one or more graph models of the venue.

The model of the venue may for instance be a two dimensional or three dimensional map of the venue. Alternatively, the model of the venue may for instance be a plurality (e.g. at least two) two dimensional maps of the venue, wherein each of the two dimensional maps is representing one floor of the venue.

A respective point-of-interest of the venue may for instance be indicative of a respective elevator, escalator or stairs connecting at least two (different) floors of the venue.

A respective graph model of the venue may for instance be indicative of a pre-calculated route attached to the venue. A graph model may, for instance, be a connectivity model, where vertices denote spaces (e.g. a room, a section of a corridor, a section of an open area) and edges denote connectivity. Connectivity describes how to go from one space to another and which transitions are allowed. Such a graph model may for instance be used to enable finding out, how one can move from one space (a vertex) to another space (a vertex) via other spaces (a set of vertices). Moreover, when the edges are associated with their metric length, the route length can be deduced.

According to an exemplary embodiment of the first exemplary aspect of the present invention, the method further comprises:
obtaining historical movement information indicative of one or more routes a respective user has used in the past, wherein the one or more pieces of control information are determined further based on the historical movement information.

A plurality of such historical movement information, e.g. from a plurality of electronic devices may for instance be obtained. It will be understood that the one or more pieces of control information may then be determined based at least partially on the plurality of pieces of historical movement information.

Alternatively or additionally, the one or more routes may for instance be represented by a (historical) origin location and a (historical) destination location. In this way, the route may for instance be determined based at least partially on the (historical) origin location and the (historical) destination location in the venue.

The historical movement information may for instance represent one or more statistical locations and/or routes, e.g. over daily hours that a respective user may have visited, e.g. frequently. This may for instance be used to determine the one or more pieces of control information, since such pieces of historical movement information may for instance enable to predict the (overall) elevator usage and therefore enable a smooth user flow in the venue.

According to an exemplary embodiment of all aspects of the present invention, the method further comprises
generating one or more weight indexes based at least partially on the historical movement information for determining potential routes which are usable by the user; and
associating the one or more weight indexes with the respective user;
wherein the one or more pieces of control information are determined further based on the one or more weight indexes.

Further, in case of a plurality of users, one or more weight indexes may for instance be generated for each user of the plurality of users, so that e.g. preferences of one or more routes the respective user utilizes, may for instance be determined (e.g. predicted).

For instance, for the pre-determined route information, one or more weight indexes may for instance be generated (e.g. created). For instance, an index table may list one or more routes, and the usage weight indexes of the respective routes in a time axis. Further, such a weight index table may for instance depend on e.g. the respective user in the venue. Such a weight index table may for instance be generated based at least partially on one or more graph models for the possible route(s). The one or more graph models may for instance be comprised by or being a part of the indoor map data of the venue.

Further, the one or more weight indexes may for instance be adapted based on current data. In this way, e.g. learning of patterns associated with a corresponding electronic device respectively its user may for instance be enabled.

The method according to the second exemplary aspect of the present invention may for instance be performed and/or controlled by a second apparatus according to the second exemplary aspect of the present invention. Such an apparatus may for instance be an electronic device.

The electronic device may for instance be a mobile device (e.g. smartphone, tablet, portable navigation device, wearable, IoT device, Bluetooth tag device, to name but a few non-limiting examples). The electronic device may for instance be portable (e.g. weigh less than 5, 4, 3, 2, or 1 kg). The electronic device may for instance comprise or be connectable to a display for displaying a route that is guided/navigated to a user. The electronic device may for instance comprise or be connectable to means for outputting sound, e.g. in form of spoken commands or information. The electronic device may for instance comprise or be connectable to one or more sensors for determining the devices position, such as for instance a Global Navigation Satellite System (GNSS) receiver, e.g. in the form of a Global Positioning System (GPS) receiver. The electronic device may for instance comprise or be connectable to one or more sensors, e.g. in the form of an accelerometer and/or a gyroscope for obtaining information. The electronic device may for instance comprise or be connectable to a receiver and/or a transmitter (e.g. a transceiver) for receiving and/or sending information.

According to an example embodiment of the second exemplary aspect of the present invention, at least the origin location of the movement information (e.g. current location of an electronic device) is gathered by one or more sensors

The one or more sensors may for instance be comprised by or being connectable to the apparatus (e.g. the electronic device; for instance a mobile device or a tag device) according to the second exemplary aspect of the present invention. The one or more sensors may for instance enable a current location in the venue of the apparatus comprising or being connectable to the one or more sensors to be determined.

The movement information may for instance be gathered (e.g. measured) by the one or more sensors. In this way, e.g. the origin location may for instance be determined to represent the current location as gathered by the one or more sensors. A respective user (or all users) of the one or more users located within the venue may for instance be tracked, e.g. through their electronic devices (e.g. mobile phones, smartphone, or the like) or they could carry a tracking tag device (for instance, a Bluetooth-based IoT device) to determine a respective users' location in the venue, e.g. at any given time. The origin location may for instance be gathered by the one or more sensors as well, e.g. by receiving an input (e.g. by the respective user of the electronic device) when he is at a destination location, wherein the input may for instance further comprise a time information indicative of when the respective user wishes to visit the destination location again. Alternatively, the destination location may for instance be obtained from a calendar information, e.g. that is stored in a memory (e.g. comprised by or connectable to the electronic device of the respective user).

The gathered movement information is output, e.g. for usage in a method according to the first exemplary aspect of the present invention, in which the movement information is obtained as a part of a plurality of pieces of movement information.

The one or more pieces of control information may for instance be received from the apparatus according to the first exemplary aspect of the present invention. This apparatus may for instance have been received a plurality of pieces of movement information, e.g. from a plurality of apparatuses according to the second exemplary aspect of the present invention. The one or more pieces of control information may thus enable a controlling of one or more elevators of the venue, e.g. to influence the usage of the one or more elevators of the venue. But further, the one or more pieces of control information can be used for determining navigation information based on the movement information and the one or more pieces of control information, e.g. to (further) influence the usage of the one or more elevators of the venue. This is enabled by determining the navigation information accordingly, e.g. to navigate a respective user of the apparatus according to the second exemplary aspect of the present invention to a (certain) respective elevator in the venue, as specified by the one or more pieces of control information. Under consideration that a plurality of users perform the method according to the second exemplary aspect, e.g. with their respective electronic devices, it is enabled to optimize (e.g. balance) the usage (e.g. load) of each of the one or more elevators of the venue.

In this way, since the one or more pieces of control information were determined under the knowledge of balancing respectively optimizing the load of the one or more elevators of the venue, a distribution of the load of the one or more elevators of the venue is enabled. Thus, a certain user may for instance be navigated to a certain elevator preventing that too many users may for instance use the same elevator.

According to an embodiment of the second exemplary aspect of the present invention, the apparatus is a mobile device or a tag device.

The tag device may for instance be an IoT device, e.g. a Bluetooth tag device that enables its (current) location in the venue to be determined or to determine its (current) location in the venue. The current location may for instance be comprised by or being represented, at least in part, by a respective movement information, e.g. that is obtained by the method according to the first exemplary aspect of the present invention.

According to an embodiment of the second exemplary aspect of the present invention, the method further comprises:
outputting historical movement information indicative of one or more routes the user has used in the past, enabling the one or more pieces of control information to be determined based on the historical movement information.

The historical movement information may for instance be used by an example embodiment of a method according to the first exemplary aspect of the present invention, as described above.

The features and example embodiments of the invention described above may equally pertain to the different aspects according to the present invention.

It is to be understood that the presentation of the invention in this section is merely by way of examples and non-limiting.

Other features of the invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE DRAWINGS

In the figures show:

FIG. 1 is a schematic high-level block diagram of a system according to the third exemplary aspect of the present invention;

FIG. 2 is a flowchart showing an example embodiment of a first method according to the first exemplary aspect of the present invention, for instance performed by server 110 of FIG. 1;

FIG. 3 is a flowchart showing an example embodiment of a second method according to the second exemplary aspect of the present invention, for instance performed by electronic device 130 of FIG. 1;

FIG. 4a-b are schematic illustrations of an indoor map of a venue, wherein FIG. 4a shows a first floor map and FIG. 4b shows a second floor map of the venue;

FIG. 5 is a schematic block diagram of a first apparatus configured to perform the first method according to the first exemplary aspect of the present invention; and

FIG. 6 is a schematic block diagram of a second apparatus configured to perform the second method according to the second exemplary aspect of the present invention.

### DETAILED DESCRIPTION OF SOME EXEMPLARY EMBODIMENTS

The following description serves to deepen the understanding of the present invention and shall be understood to complement and be read together with the description as provided in the above summary section of this specification.

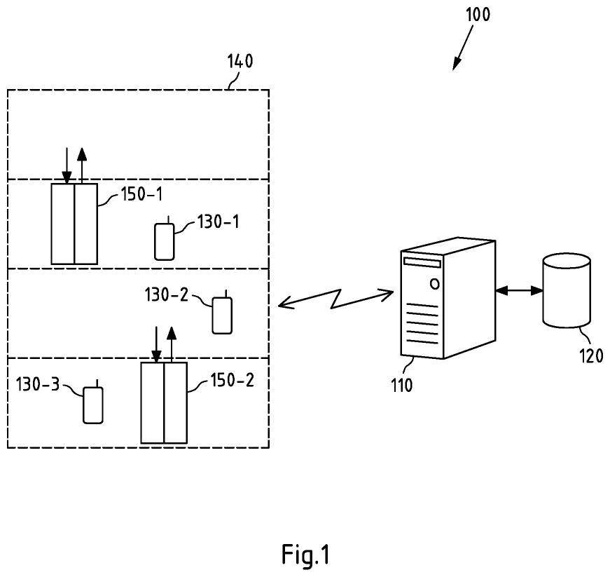

FIG. 1 is a schematic high-level block diagram 100 according to an exemplary aspect of the present invention. Such a system 100 may for instance represent a client-server (respectively server cloud) architecture as used by one or more exemplary embodiments according to all exemplary aspects of the present invention.

System 100 comprises a server 110, an optional database 120, one or more electronic devices 130 (e.g. a smartphone, tablet, portable navigation device, wearable, IoT device, to name but a few non-limiting examples), one or more elevators 150 located in a venue 140 (e.g. a high rise building comprising a plurality of floors). The floors in the venue are schematically illustrated by the stroked horizontal lines in the venue 140. The arrows schematically illustrated above the elevators 150 indicate that the respective elevators 150 could transfer between two floors of the venue 140.

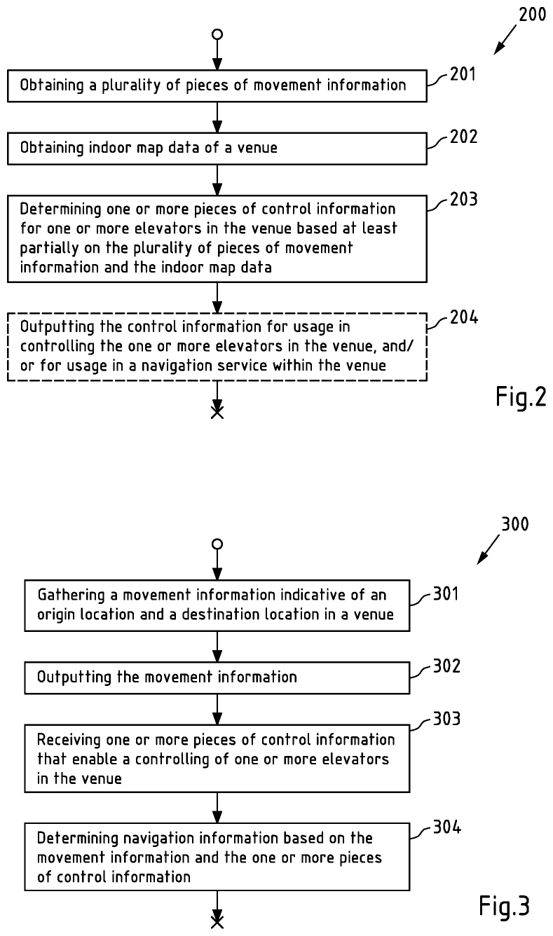

The server 110 may alternatively be embodied as a server cloud (e.g. a plurality of servers connected, e.g. via the Internet and providing services at least partially jointly). The server 110 may for instance be configured to perform the first method according to the first exemplary aspect of the present invention (e.g. flowchart 200 of FIG. 2). Each of the electronic devices 130 located within the venue 140 may for instance be configured to perform the second method according to the second exemplary aspect of the present invention (flowchart 300 of FIG. 3).

The database 120 may for instance be optional. The database 120 may for instance be comprised by or connectable to the server 110. The database 120 may alternatively be comprised by or be a part of the venue 140, wherein server 110 may for instance have access (e.g. by being connectable) to the database 120. The database 120 may for instance comprise or be a part of a memory, e.g. for storing one or more pieces of movement information, indoor map data, one or more pieces of control information, one or more pieces of navigation information, one or more weight indexes, one or more pieces of historical movement information, or a combination thereof, to name but a few non-limiting examples.

Communication between at least one of the electronic devices 130, and/or at least one of the elevators 150 and the server 110 may for instance take place at least partially in a wireless fashion, e.g. based on cellular radio communication, on Bluetooth based communication, and/or on Wireless Local Area Network (WLAN) based communication, to name but a few non-limiting examples. In this way, mobility of the electronic devices 130, in particular within the venue 140, is guaranteed.

Example embodiments of the present invention enable to gather a respective movement information by the electronic devices 130-1 to 130-3 located in the venue 140. Then, those gathered movement information are output by the respective electronic devices 130-1 to 130-3, e.g. to server 110. The server 110 can obtain those plurality of pieces of movement information, obtain indoor map data of the venue in case the indoor map data is not available at the server 110 (e.g. then, the indoor map data can be obtained from the database 120, to name but one non-limiting example), and determine one or more pieces of control information. Then, the one or more pieces of control information may for instance be output, e.g. from the server 110 back to at least one of the electronic devices 130-1 to 130-3. At least one of the electronic devices 130-1 to 130-3 may for instance use the received one or more pieces of control information to determine navigation information, e.g. to navigate a respective user of at least one of the electronic devices 130-1 to 130-3 from an origin location in the venue 140 to a destination location in the venue 140, wherein a route represented by the navigation information may for instance be determined under consideration of the overall usage of the elevators 150-1 to 150-2 of the venue 140 so that e.g. load between the elevators 150-1 to 150-2 of the venue 140 can be balanced. Further, after determining the one or more pieces of control information by the server 110, the one or more pieces of control information are output to the elevators 150-1 to 150-2 of the venue 140. Thus, the elevators 150-1 to 150-2 of the venue 140 are enabled to control transfers respectively tours between floors of the venue 140 based on the one or more pieces of control information.

FIG. 2 is a flowchart 200 showing an example embodiment of a method according to the first exemplary aspect of the present invention. This flowchart may for instance be performed by server 110 of FIG. 1.

In a first step 201, a plurality of pieces of movement information is obtained (e.g. received), e.g. from a plurality of electronic devices (e.g. electronic devices 130-1 to 130-3 of FIG. 1). The plurality of pieces of movement information may for instance be obtained via a communication network (not shown in FIG. 1), e.g. a cellular based, Bluetooth based, and/or WLAN based communication network.

In a second step 202, indoor map data of a venue (e.g. venue 140 of FIG. 1) is obtained, in case the indoor map data is not available at the server 110, e.g. from a memory (e.g. comprised by database 120 of FIG. 1 and connectable to server 110 of FIG. 1, or comprised by server 110 of FIG. 1).

In a third step 203, one or more pieces of control information are determined. The one or more pieces of control information enable to control one or more elevators of a venue (e.g. elevators 150-1 to 150-2 of the venue 140 of FIG. 1). The one or more pieces of control information are determined based at least partially on the plurality of pieces of movement information obtained in step 201 of FIG. 2, and the indoor map data, e.g. obtained in step 202 of FIG. 2 in case the indoor map data was not available at the server 110 of FIG. 1.

In an optional fourth step 204, the one or more pieces of control information are output, e.g. to the one or more elevators 150-1 to 150-2 of the venue 140 of FIG. 1, and/or to the one or more electronic devices 130-1 to 130-3 of FIG. 1 for further usage, e.g. as described in the above summary section of this specification.

FIG. 3 is a flowchart 300 showing an example embodiment of a method according to the second exemplary aspect of the present invention. This flowchart may for instance be performed by at least one of the electronic device 130-1 to 130-3 of FIG. 1.

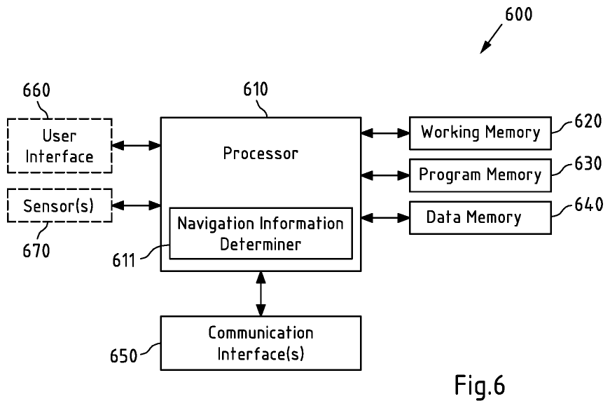

In a first step 301, a movement information is gathered (e.g. measured). The movement information may for instance be gathered by one or more sensors, e.g. sensors 670 of apparatus 600 of FIG. 6.

In a second step 302, the movement information are output (e.g. sent), e.g. from the respective electronic device (e.g. at least one of the electronic devices 130-1 to 130-3 of FIG. 1) to a server (e.g. server 110 of FIG. 1).

In a third step 303, one or more pieces of control information are received, e.g. from the server 110 of FIG. 1 after this server 110 of FIG. 1 may for instance have determined the one or more pieces of control information.

In a fourth step 304, navigation information are determined based on the movement information gathered in step 301 and the one or more pieces of control information received in step 303, enabling to navigate a user of the respective electronic device performing and/or controlling the flowchart 300 from an origin location of a venue (e.g. venue 140 of FIG. 1) to a destination location of the venue.

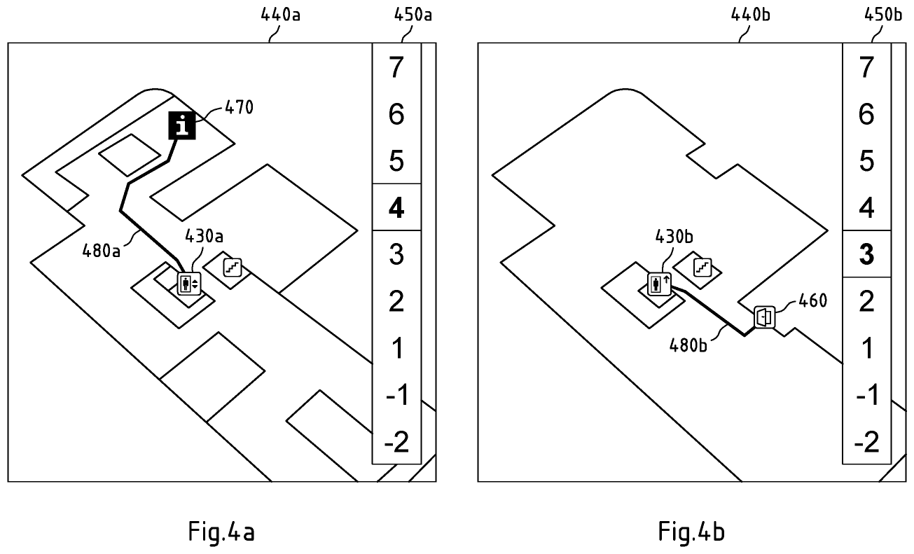

FIG. 4 shows a schematic illustration of an indoor map of a venue, wherein FIG. 4a shows a first floor map 440a (floor 4 of 7 of the venue) and FIG. 4b shows a second floor map 440b (floor 3 of 7 of the venue).

FIGS. 4a and 4b show an elevator 430a respectively 430b that enables one or more users in the venue to transfer between the floors of the venue. Further, FIGS. 4a and 4b show a legend 450a, 450b indicating the floor level that is shown in the respective FIG. 4a, 4b. Further, FIGS. 4a and 4b show a route 480a, 480b that may enable the navigation of a user from an origin location 460 (shown in the indoor map 440b of FIG. 4b) to a destination location 470 (shown in the indoor map 440a of FIG. 4a) in the venue.

Example embodiments of the present invention enable e.g. calling elevators to floors of a venue, wherein the usage of the elevators may for instance be influenced (e.g. optimized), e.g. by calling/using the elevators in a venue (e.g. building) based on one or more of the following:
Number of people needing an elevator;
   in the origin floor;
   in the destination floor; and
   in the floors between the origin and destination; and
The known or estimated origin and destination location (e.g. floor) and the required elevator routes.

The origin and the destination floors may for instance be based on:
Indoor positioning/tracking; and/or
Indoor routing/navigation.

Moreover, origin/destination location (e.g. floor) may for instance be understood from the calendar (e.g. represented by a calendar information) e.g. from the meeting rooms/places allocated in the calendars. Such a calendar information can be considered as the information on where the individual (user) will most likely go next.

The output of these information may for instance be used to create a forecast for the required elevator routes in the building, respectively considered by determining the one or more pieces of control information. Such an elevator route data may for instance be constantly changing based on the location of the user(s) and the route(s) he (they) will take in the venue. Further, historical/statistical location and route data over the daily hours may for instance be used to predict the elevator usage and therefore enable a smooth user (e.g. visitor) flow in the building.

The elevator usage optimization enabled by determining the one or more pieces of control information may for instance be partitioned by considering the two following aspects:

a. Understanding the amount of users needing an elevator in a floor at any given time; and
b. Understanding where those users want to move.

To exemplify, in a case with two users approaching an elevator—the question may for instance arise whether one or two elevators are to be called to that floor in a predictive fashion. If both users go up or down, calling one elevator is sufficient. However, if one user wants to go up and the other user wants to go down, then two elevators are needed to be called. Therefore, understanding the destination location (e.g. floor) may for instance be advantageous, when the elevator usage is being optimized by determining one or more pieces of control information according to the first method of the first exemplary aspect of the present invention.

### Aspect a:

Understanding the destination location (e.g. floor) may for instance be possible via indoor routing. For instance, in the building, e.g. a so-called smart office system may for instance be deployed, which allows users (e.g. employees located in the building) to use location technologies to improve their productivity. Such features allow employees to run e.g. an application in their electronic devices (e.g. mobile devices). The application may for instance run indoor positioning (thus, knows employee location) and indoor maps (thus, understands where different locations are indoors). Now, the application may for instance access the employee's calendar, e.g. represented by a calendar information. When there is a meeting according to the calendar information, the application may for instance allow the employee to route/navigate the employee to the meeting room (see indoor routing example in the FIG. 4a, 4b—the routing is from the third floor of the venue to the fourth floor of the venue). This information may for instance be used as a (direct) input to the elevator usage optimization (e.g. by determining one or more pieces of control information):
the employee location is known—it is known very precisely, when the user arrives at the elevator (this allows further optimization when the determining the one or more pieces of control information is further based on this feature);
if there is a floor change between the origin/current location and destination location, the employee will need to take stairs or use an elevator. A relatively probability of these two options may for instance be estimated, e.g. based on the number of floors to change (the higher the number of floors to change, the more probable it is that the employee will use an elevator), the current trajectory (towards elevator or stairs) and historical patterns (the application may for instance learn the employee habits); and
the destination location (e.g. floor) is known for sure based on the routing information.

### Aspect b:

Understanding the origin and destination location (e.g. floor) is sometimes possible just by analyzing the calendar of the user. The system optimizing elevator usage could understand, where individuals (users) are (via indoor positioning or tracking) and have access to calendars of the individuals (users). In such a case, it may for instance be deducible, where the individual (user) is heading to (e.g. the person is in the floor 3 now, and has a meeting in the floor 7 in five minutes—then it is plausible that the person is heading to the floor 7).

The method according to the first exemplary aspect of the present invention may for instance run totally in a (server) cloud (e.g. configured as a cloud component)—the users in the venue may for instance be tracked e.g. through their electronic devices (e.g. mobile phones) or they could carry a tracking tag (for instance, a Bluetooth-based one; Bluetooth tag-device) to understand users' location in the venue at any given time. Additionally, the cloud component may for instance have access to calendar information of the respective users, allowing to deduce a most probable destination location in the venue, e.g. to which the respective user may for instance be going. In this case, there might not even be a need to have any application or the like running in the users' electronic device.

In this way, e.g. lower construction costs can be achieved, since e.g. fewer elevators are needed in the venue. Further, more efficient space utilization can be achieved, since elevator shafts take less space, and a better experience for users (e.g. employees) of the venue (e.g. building) can be achieved as transportation flow between floors of the venue is smooth and efficient.

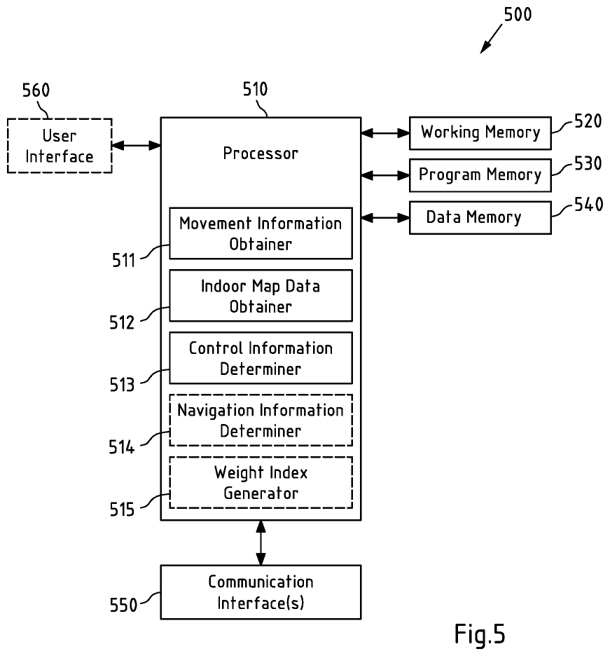

FIG. 5 is a schematic block diagram of an apparatus 500 according to an exemplary aspect of the present invention, which may for instance represent server 110 of FIG. 1.

Apparatus 500 comprises a processor 510, working memory 520, program memory 530, data memory 540, communication interface(s) 550, and an optional user interface 560.

Apparatus 500 may for instance be configured to perform and/or control or comprise respective means (at least one of 510 to 560) for performing and/or controlling the method according to the first exemplary aspect of the present invention. Apparatus 500 may as well constitute an apparatus comprising at least one processor (510) and at least one memory (520) including computer program code, the at least one memory and the computer program code configured to, with the at least one processor, cause an apparatus, e.g. apparatus 500 at least to perform and/or control the method according to the first exemplary aspect of the invention of the present invention.

Processor 510 may for instance comprise a movement information obtainer 511 as a functional and/or structural unit. Movement information obtainer 511 may for instance be configured to obtain a plurality of pieces of movement information (see step 201 of FIG. 2).

Processor 510 may for instance comprise an indoor map data obtainer 512 as a functional and/or structural unit. Indoor map data obtainer 512 may for instance be configured to obtain indoor map data of a venue (see step 202 of FIG. 2).

Processor 510 may for instance comprise a control information determiner 513 as a functional and/or structural unit. Control information determiner 513 may for instance be configured to determine one or more pieces of control information (see step 203 of FIG. 2).

Processor 510 may for instance comprise an optional navigation information determiner 514 as a functional and/or structural unit. Optional navigation information determiner 514 may for instance be configured to determine navigation information, e.g. for usage in indoor navigation services, e.g. by an electronic device (e.g. electronic device 130 of FIG. 1).

Processor 510 may for instance comprise an optional weight index generator 515 as a functional and/or structural unit. Weight index generator 515 may for instance be configured to generate one or more weight indexes.

Processor 510 may for instance further control the memories 520 to 540, the communication interface(s) 550, and the optional user interface 560.

Processor 510 may for instance execute computer program code stored in program memory 530, which may for instance represent a computer readable storage medium comprising program code that, when executed by processor 510, causes the processor 510 to perform the method according to the first exemplary aspect of the present invention.

Processor 510 (and also any other processor mentioned in this specification) may be a processor of any suitable type. Processor 510 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 510 may for instance be an application processor that runs an operating system.

Program memory 530 may also be included into processor 510. This memory may for instance be fixedly connected to processor 510, or be at least partially removable from processor 510, for instance in the form of a memory card or stick. Program memory 530 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 530 may also comprise an operating system for processor 510. Program memory 530 may also comprise a firmware for apparatus 500.

Apparatus 500 comprises a working memory 520, for instance in the form of a volatile memory. It may for instance be a Random Access Memory (RAM) or Dynamic RAM (DRAM), to give but a few non-limiting examples. It may for instance be used by processor 510 when executing an operating system and/or computer program.

Data memory 540 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory 540 may for instance store one or more pieces of movement information, indoor map data, one or more pieces of control information, one or more pieces of navigation information, one or more weight indexes, one or more pieces of historical movement information, or a combination thereof, to name but a few non-limiting examples.

Communication interface(s) 550 enable apparatus 500 to communicate with other entities, e.g. with electronic device 130, and/or with database 120 of FIG. 1, and/or with elevator 150 of FIG. 1. The communication interface(s) 550 may for instance comprise a wireless interface, e.g. a cellular radio communication interface and/or a WLAN interface) and/or wire-bound interface, e.g. an IP-based interface, for instance to communicate with entities via the Internet.

User interface 560 is optional and may comprise a display for displaying information to a user and/or an input device (e.g. a keyboard, keypad, touchpad, mouse, etc.) for receiving information from a user.

Some or all of the components of the apparatus 500 may for instance be connected via a bus. Some or all of the components of the apparatus 500 may for instance be combined into one or more modules.

FIG. 6 is a schematic block diagram of an apparatus 600 according to an exemplary aspect of the present invention, which may for instance represent the electronic device 130 of FIG. 1.

Apparatus 600 comprises a processor 610, working memory 620, program memory 630, data memory 640, communication interface(s) 650, an optional user interface 660 and (an) optional sensor(s) 670.

Apparatus 600 may for instance be configured to perform and/or control or comprise respective means (at least one of 610 to 670) for performing and/or controlling the method according to the second exemplary aspect of the present invention. Apparatus 600 may as well constitute an apparatus comprising at least one processor (610) and at least one memory (620) including computer program code, the at least one memory and the computer program code configured to, with the at least one processor, cause an apparatus, e.g. apparatus 600 at least to perform and/or control the method according to the second exemplary aspect of the invention of the present invention.

Processor 610 may for instance comprise a navigation information determiner 611 as a functional and/or structural unit. Navigation information determiner 611 may for instance be configured to determine a navigation information (see step 304 of FIG. 3). Processor 610 may for instance further control the memories 620 to 640, the communication interface(s) 650, the optional user interface 660 and the optional sensor(s) 670.

Processor 610 may for instance execute computer program code stored in program memory 630, which may for instance represent a computer readable storage medium comprising program code that, when executed by processor 610, causes the processor 610 to perform the method according to the second exemplary aspect of the present invention.

Processor 610 (and also any other processor mentioned in this specification) may be a processor of any suitable type. Processor 610 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 610 may for instance be an application processor that runs an operating system.

Program memory 630 may also be included into processor 610. This memory may for instance be fixedly connected to processor 610, or be at least partially removable from processor 610, for instance in the form of a memory card or stick. Program memory 630 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 630 may also comprise an operating system for processor 610. Program memory 630 may also comprise a firmware for apparatus 600.

Apparatus 600 comprises a working memory 620, for instance in the form of a volatile memory. It may for instance be a Random Access Memory (RAM) or Dynamic RAM (DRAM), to give but a few non-limiting examples. It may for instance be used by processor 610 when executing an operating system and/or computer program.

Data memory 640 may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory 640 may for instance store a movement information, one or more pieces of control information, navigation information, historical movement information, or a combination thereof, to name but a few non-limiting examples.

Communication interface(s) 650 enable apparatus 600 to communicate with other entities, e.g. with server 110 of FIG. 1. The communication interface(s) 650 may for instance comprise a wireless interface, e.g. a cellular radio communication interface and/or a WLAN interface) and/or wire-bound interface, e.g. an IP-based interface, for instance to communicate with entities via the Internet.

User interface 660 is optional and may comprise a display for displaying information to a user and/or an input device (e.g. a keyboard, keypad, touchpad, mouse, etc.) for receiving information from a user.

Sensor(s) 670 are optional and may for instance comprise a GPS sensor to gather location information indicative of the (current) location of the apparatus 600, a barometric sensor, e.g. to gather pressure information indicative of a (relative) altitude of the apparatus 600, an accelerometer to gather acceleration information indicative of a trajectory of the apparatus 600, and/or a gyroscope to gather position information indicative of an orientation of the apparatus 600, to name but a few non-limiting examples.

Some or all of the components of the apparatus 600 may for instance be connected via a bus. Some or all of the components of the apparatus 600 may for instance be combined into one or more modules.

The following embodiments shall also be considered to be disclosed:

### Embodiment 1

A first method (e.g. performed by at least one server), comprising:
obtaining a plurality of pieces of movement information, wherein a respective movement information of the plurality of pieces of movement information is at least indicative of an origin location and a destination location in a venue;
obtaining indoor map data of the venue in case the indoor map data is not available, wherein the indoor map data is indicative of at least one or more connections one or more users can utilize for transferring between floors of the venue, wherein the indoor map data comprises or is associated with one or more pre-determined route information indicative of a pre-determined route within the venue; and
determining one or more pieces of control information for one or more elevators of the venue based at least partially on the plurality of pieces of movement information and the indoor map data, wherein a respective control information of the one or more pieces of control information enables a controlling of a respective elevator of the one or more elevators, and wherein the one or more pieces of control information together enable to influence an overall elevator usage of the one or more elevators of the venue.

### Embodiment 2

The method according to embodiment 1, wherein the plurality of pieces of movement information are obtained based at least partially on one or more pieces of calendar information, wherein each of the one or more pieces of calendar information is indicative of a destination location and a time at which a respective user of the one or more users wishes to reach the destination location of the calendar information, wherein a respective movement information of the plurality of pieces of movement information is deduced from a current location of a respective electronic device of the respective user and the destination location of the calendar information.

### Embodiment 3

The method according to any of the preceding embodiments, wherein at least one respective movement information of the one or more pieces of movement information comprises or is associated with a trajectory information indicative of a current direction of movement of a respective electronic device of a respective user, wherein the one or more pieces of control information are determined further based on the trajectory information.

### Embodiment 4

The method according to any of the preceding embodiments, further comprising:
outputting the control information for usage in controlling the one or more elevators of the venue, and/or for usage in a navigation service within the venue, wherein the navigation service enables a respective electronic device of a respective user to navigate from an origin location to a destination location of the venue.

### Embodiment 5

The method according to any of the preceding embodiments, further comprising:
determining navigation information based at least partially on a respective movement information of the plurality of pieces of movement information and the one or more pieces of control information, wherein the navigation information is indicative of a certain route enabling a respective user to get from the origin location to the destination location of the respective movement information.

### Embodiment 6

The method according to any of the preceding embodiments, wherein the one or more pieces of control information are determined further based on a plurality of pieces of time information indicative of a time a user wishes to reach a destination location in the venue, wherein each of the plurality of pieces of movement information is associated with such a time information, wherein the one or more pieces of control information are determined by aggregating the plurality of pieces of movement information associated with the plurality of pieces of time information.

### Embodiment 7

The method according to any of the preceding embodiments, wherein at least a part of the plurality of pieces of movement information are gathered by one or more sensors.

### Embodiment 8

The method according to any of the embodiments 5 to 7, wherein the navigation information is determined based on a probability information indicative of a likelihood that the user utilizes a certain connection to transfer from one floor of the venue to another.

### Embodiment 9

The method according to embodiment 8, wherein a respective control information of the one or more pieces of control information for a respective elevator of the one or more elevators of the venue is determined further based on one or more of the following parameters i) to iii), which are deducable from the plurality of pieces of movement information:
i) number of users requiring an elevator in an origin floor of the respective elevator;
ii) number of users requiring an elevator in a destination floor of the respective elevator; and
iii) number of users requiring an elevator in one or more floors in between the origin floor and the destination floor of the respective elevator.

### Embodiment 10

The method according to any of the preceding embodiments, wherein the indoor map data is indicative of one or more of the following:
i) a model of the venue;
ii) one or more points-of-interest of the venue; and
iii) one or more graph models of the venue.

### Embodiment 11

The method according to any of the preceding embodiments, further comprising:
obtaining historical movement information indicative of one or more routes a respective user has used in the past, wherein the one or more pieces of control information are determined further based on the historical movement information.

### Embodiment 12

The method according to embodiment 11, further comprising:
generating one or more weight indexes based at least partially on the historical movement information for determining potential routes which are usable by the user; and
associating the one or more weight indexes with the respective user;
wherein the one or more pieces of control information are determined further based on the one or more weight indexes.

### Embodiment 13

A second method (e.g. performed by at least one electronic device), comprising:
gathering a movement information indicative of an origin location and a destination location in a venue;
outputting the movement information;
receiving one or more pieces of control information that enable a controlling of one or more elevators of the venue; and
determining navigation information based on the movement information and the one or more pieces of control information, wherein the navigation information enables to navigate a user in the venue from the origin location to the destination location.

### Embodiment 14

The method according to embodiment 13, wherein the apparatus is a mobile device or a tag device.

### Embodiment 15

The method according to embodiment 13 or embodiment 14, wherein the movement information is gathered by one or more sensors enabling a current location in the venue to be determined.

### Embodiment 16

The method according to any of the embodiments 13 to 15, further comprising
outputting historical movement information indicative of one or more routes the user has used in the past, enabling the one or more pieces of control information to be determined based on the historical movement information.

### Embodiment 17

A computer program code, said computer program code when executed by a processor causing an apparatus to perform the method according to any of the embodiments 1 to 12.

### Embodiment 18

A computer program code, said computer program code when executed by a processor causing an apparatus to perform the method according to any of the embodiments 13 to 17.

### Embodiment 19

A non-transitory computer readable storage medium in which computer program code is stored, the computer program code when executed by a processor causing at least one apparatus to perform the method according to any of the embodiments 1 to 12.

### Embodiment 20

A non-transitory computer readable storage medium in which computer program code is stored, the computer program code when executed by a processor causing at least one apparatus to perform the method according to any of the embodiments 13 to 17.

### Embodiment 21

An apparatus, said apparatus comprising means for performing the method according to any of the embodiments 1 to 12.

### Embodiment 22

An apparatus, said apparatus comprising means for performing the method according to any of the embodiments 13 to 17.

### Embodiment 23

An apparatus, said apparatus comprising at least one processor and at least one memory including computer program code, the at least one memory and the computer program code configured to, with the at least one processor, cause said apparatus at least to perform the method according to any of the embodiments 1 to 12.

### Embodiment 24

An apparatus, said apparatus comprising at least one processor and at least one memory including computer program code, the at least one memory and the computer program code configured to, with the at least one processor, cause said apparatus at least to perform the method according to any of the embodiments 13 to 17.

### Embodiment 25

A system comprising:
a plurality of apparatuses according to embodiment 22 or embodiment 24, wherein each respective apparatus of the plurality of apparatuses is configured to perform the method according to any of the embodiments 13 to 17; and
at least one apparatus according to embodiment 21 or embodiment 23, which is configured to perform the method according to any of the embodiments 1 to 12.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect of the invention on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature of the invention and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The invention has been described above by means of example embodiments. It should be noted that there are alternative ways and variations which are obvious to a skilled person in the art and can be implemented without deviating from the scope of the appended claims.

1. An apparatus comprising at least one processor and at least one memory including computer program code, the at least one memory and the computer program code configured to, with the at least one processor, cause the apparatus to at least perform:
obtaining a plurality of pieces of movement information, wherein a respective movement information of the plurality of pieces of movement information is at least indicative of an origin location and a destination location in a venue;
obtaining indoor map data of the venue in case the indoor map data is not available, wherein the indoor map data is indicative of at least one or more connections one or more users can utilize for transferring between floors of the venue, wherein the indoor map data comprises or is associated with one or more pre-determined route information indicative of a pre-determined route within the venue; and
determining one or more pieces of control information for one or more elevators of the venue based at least partially on the plurality of pieces of movement information and the indoor map data, wherein a respective control information of the one or more pieces of control information enables a controlling of a respective elevator of the one or more elevators, and wherein the one or more pieces of control information together enable to influence an overall elevator usage of the one or more elevators of the venue.

2. The apparatus according to claim 1, wherein the plurality of pieces of movement information are obtained based at least partially on one or more pieces of calendar information, wherein each of the one or more pieces of calendar information is indicative of a destination location and a time at which a respective user of the one or more users wishes to reach the destination location of the calendar information, wherein a respective movement information of the plurality of pieces of movement information is deduced from a current location of a respective electronic device of the respective user and the destination location of the calendar information.

3. The apparatus according to claim 1, wherein at least one respective movement information of the one or more pieces of movement information comprises or is associated with a trajectory information indicative of a current direction of movement of a respective electronic device of a respective user, wherein the one or more pieces of control information are determined further based on the trajectory information.

4. The apparatus according to claim 1, the at least one memory and the computer program code configured to, with the at least one processor, cause the apparatus further to perform:
outputting the control information for usage in controlling the one or more elevators of the venue, and/or for usage in a navigation service within the venue, wherein the navigation service enables a respective electronic device of a respective user to navigate from an origin location to a destination location of the venue.

5. The apparatus according to claim 1, the at least one memory and the computer program code configured to, with the at least one processor, cause the apparatus further to perform:
determining navigation information based at least partially on a respective movement information of the plurality of pieces of movement information and the one or more pieces of control information, wherein the navigation information is indicative of a certain route enabling a respective user to get from the origin location to the destination location of the respective movement information.

6. The apparatus according to claim 1, wherein the one or more pieces of control information are determined further based on a plurality of pieces of time information indicative of a time a user wishes to reach a destination location in the venue, wherein each of the plurality of pieces of movement information is associated with such a time information, wherein the one or more pieces of control information are determined by aggregating the plurality of pieces of movement information associated with the plurality of pieces of time information.

7. The apparatus according to claim 1, wherein at least a part of the plurality of pieces of movement information are gathered by one or more sensors.

8. The apparatus according to claim 5, wherein the navigation information is determined based on a probability information indicative of a likelihood that the user utilizes a certain connection to transfer from one floor of the venue to another.

9. The apparatus according to claim 8, wherein a respective control information of the one or more pieces of control information for a respective elevator of the one or more elevators of the venue is determined further based on one or more of the following parameters i) to iii), which are deducable from the plurality of pieces of movement information:
i) number of users requiring an elevator in an origin floor of the respective elevator;
ii) number of users requiring an elevator in a destination floor of the respective elevator; and
iii) number of users requiring an elevator in one or more floors in between the origin floor and the destination floor of the respective elevator.

10. The apparatus according to claim 1, wherein the indoor map data is indicative of one or more of the following:
i) a model of the venue;
ii) one or more points-of-interest of the venue; and
iii) one or more graph models of the venue.

11. The apparatus according to claim 1, the at least one memory and the computer program code configured to, with the at least one processor, cause the apparatus further to perform:
obtaining historical movement information indicative of one or more routes a respective user has used in the past, wherein the one or more pieces of control information are determined further based on the historical movement information.

12. The apparatus according to claim 11, the at least one memory and the computer program code configured to, with the at least one processor, cause the apparatus further to perform:
generating one or more weight indexes based at least partially on the historical movement information for determining potential routes which are usable by the user; and
associating the one or more weight indexes with the respective user;
wherein the one or more pieces of control information are determined further based on the one or more weight indexes.

13. An apparatus comprising at least one processor and at least one memory including computer program code, the at least one memory and the computer program code configured to, with the at least one processor, cause the apparatus to at least perform:
gathering a movement information indicative of an origin location and a destination location in a venue;
outputting the movement information;
receiving one or more pieces of control information that enable a controlling of one or more elevators of the venue; and
determining navigation information based on the movement information and the one or more pieces of control information, wherein the navigation information enables to navigate a user in the venue from the origin location to the destination location.

14. The apparatus according to claim 13, wherein the apparatus is a mobile device or a tag device.

15. The apparatus according to claim 13, wherein at least the origin location of movement information is gathered by one or more sensors enabling a current location in the venue to be determined.

16. The apparatus according to claim 13, the at least one memory and the computer program code configured to, with the at least one processor, cause the apparatus further to perform:
outputting historical movement information indicative of one or more routes the user has used in the past, enabling the one or more pieces of control information to be determined based on the historical movement information.

17. A system, comprising:
a plurality of first apparatuses, each first apparatus comprising at least one processor and at least one memory including computer program code, the at least one memory and the computer program code configured to, with the at least one processor, cause the respective first apparatus to at least perform:
obtaining a plurality of pieces of movement information, wherein a respective movement information of the plurality of pieces of movement information is at least indicative of an origin location and a destination location in a venue;
obtaining indoor map data of the venue in case the indoor map data is not available, wherein the indoor map data is indicative of at least one or more connections one or more users can utilize for transferring between floors of the venue, wherein the indoor map data comprises or is associated with one or more pre-determined route information indicative of a pre-determined route within the venue; and
determining one or more pieces of control information for one or more elevators of the venue based at least partially on the plurality of pieces of movement information and the indoor map data, wherein a respective control information of the one or more pieces of control information enables a controlling of a respective elevator of the one or more elevators, and wherein the one or more pieces of control information together enable to influence an overall elevator usage of the one or more elevators of the venue; and
at least one second apparatus comprising at least one processor and at least one memory including computer program code, the at least one memory and the computer program code configured to, with the at least one processor, cause the second apparatus to at least perform:
gathering a movement information indicative of an origin location and a destination location in a venue;
outputting the movement information;
receiving one or more pieces of control information that enable a controlling of one or more elevators of the venue; and
determining navigation information based on the movement information and the one or more pieces of control information, wherein the navigation information enables to navigate a user in the venue from the origin location to the destination location.
